(19) United States
(12) Patent Application Publication
(10) Pub. No.: US 2006/0016643 A1
(43) Pub. Date: Jan. 26, 2006

(54) Wheel chock

(76) Inventors: David Blumenthal, Bimingham, AL (US); Mitchell Smallwood, Oakman, AL (US); William Ken Hall, McCalla, AL (US)

Correspondence Address: Raymond Jones;IP Law Global, P.C., Suite 550 - PMB 5537, 11921 Freedom Drive, Reston, VA, 20190, US

(21) Appl. No.: 11/151,652

(22) Filed: Jun. 14, 2005

Related U.S. Application Data
(60) Provisional application No. 60/579,672, filed on Jun. 16, 2004.

(51) Int. Cl. B60T 3/00

(52) U.S. Cl. 188/4 R

(57) ABSTRACT

A wheel chock having a threaded portion at one end of the chock and extending from the chock, a lower surface of the threaded portion is spaced a certain distance from a lower surface of the chock itself, such that a knot formed below the extended portion would not extend beyond a plane defined by the lower surface of the chock. Alternatively, the extended threaded portion may extend to the lower surface of the chock, but the chock contains an internal cavity of sufficient size to house a knot in a line, without the knot extending beyond a plane defined by the lower surface of the chock. A traction layer may be fixed to the lower surface of the chock to provide additional traction or holding power.

### RELATED APPLICATIONS

This application claims priority from U.S. Provisional Patent Application No. 60/579,672, filed Jun. 16, 2004, which is hereby incorporated by reference in its entirety.

### BACKGROUND OF THE INVENTION

1. Field of the Invention

The invention is broadly directed to wheel chocks, and more specifically to a wheel chock having improved traction and stability.

2. Description of the Related Art

There exist a wide variety of wheel chock designs that are placed either in front of, or behind a tire, or both, to prevent a stationary vehicle or aircraft from rolling forward or backward.

When wheel chocks are used in pairs for placement in front of and behind a tire, the chocks are typically connected to each other by a line, which may either be rope, wire or other equivalent means of connection. Frequently this involves threading the distal end of a rope or wire through a hole located near an end of the chock and tying a knot in the distal end to prevent the rope from being pulled back through the hole. The knot, however, may contact the ground and over time, can fray or be severed, thereby causing the rope to be pulled back through the hole. Also, the knot creates some instability in the chocks when the knot contacts the ground, because the chock does not lie flat.

Another problem with wheel chocks is slippage, which is caused by the heavier vehicle or plane pushing against the relatively small and lightweight chock, causing the chock to slide, which negates the purpose of the chock to prevent the vehicle or plane from moving.

Accordingly, a need exists for an improved wheel chock with improved traction and greater stability.

### SUMMARY OF THE INVENTION

In one embodiment there is provided a wheel chock having a threaded portion at one end of the chock and extending from the chock, where at least the lower surface of the threaded portion is spaced a certain distance from the lower surface of the chock itself. In the context of this disclosure, the term threaded refers to a through hole that is relatively smooth to allow the passing of a line therethrough.

In another embodiment, there is provided a wheel chock having a threaded portion at one end of the chock and extending from the chock, where the extended threaded portion contains a cavity of sufficient size to house a knot in a rope, without the knot extending beyond a plane defined by the lower surface of the chock.

In still another embodiment, there is provided a traction pad fixed to the lower surface of the chock, where the traction pad is usable with either embodiment described above.

### BRIEF DESCRIPTION OF THE DRAWINGS

The above objects and other advantages of the present invention will become more apparent by describing in detail some preferred embodiments thereof with reference to the attached drawings in which:

FIG. 1 is a perspective view of an embodiment of a wheel chock;

FIG. 2 is a side view of the wheel chock of FIG. 1 in accordance with an embodiment of the invention;

FIG. 3 is a perspective view of the wheel chock in accordance with an alternate embodiment of the invention;

FIG. 4 is a side view of the wheel chock of FIG. 3 in accordance with an alternate embodiment of the invention;

FIG. 5 is a plan view of a traction pad which may be affixed to the bottom surface of the wheel chock;

FIG. 6 is an end view of the traction pad in accordance with an embodiment of the invention showing a means for attaching the traction pad to the wheel chock;

FIG. 7 is an end view of the wheel chock in accordance with an embodiment of the invention showing a companion means for attaching the traction pad to the wheel chock; and

FIG. 8 is a side view of a portion of the traction pad affixed to the respective portion of the wheel chock, and enclosing an internal cavity housing the knotted line.

### DETAILED DESCRIPTION OF PREFERRED EMBODIMENTS

The present invention will now be described more fully with reference to the accompanying drawings, in which preferred embodiments of the invention are shown. The invention may, however, be embodied in many different forms and should not be construed as being limited to the embodiments set forth herein. Rather, the embodiments are provided so that this disclosure will be thorough and complete, and will fully convey the concept of the invention to those skilled in the art.

Broadly described, the present invention improves the traction and stability of a wheel chock, thereby providing additional holding power for a vehicle or airplane sought to be secured in place.

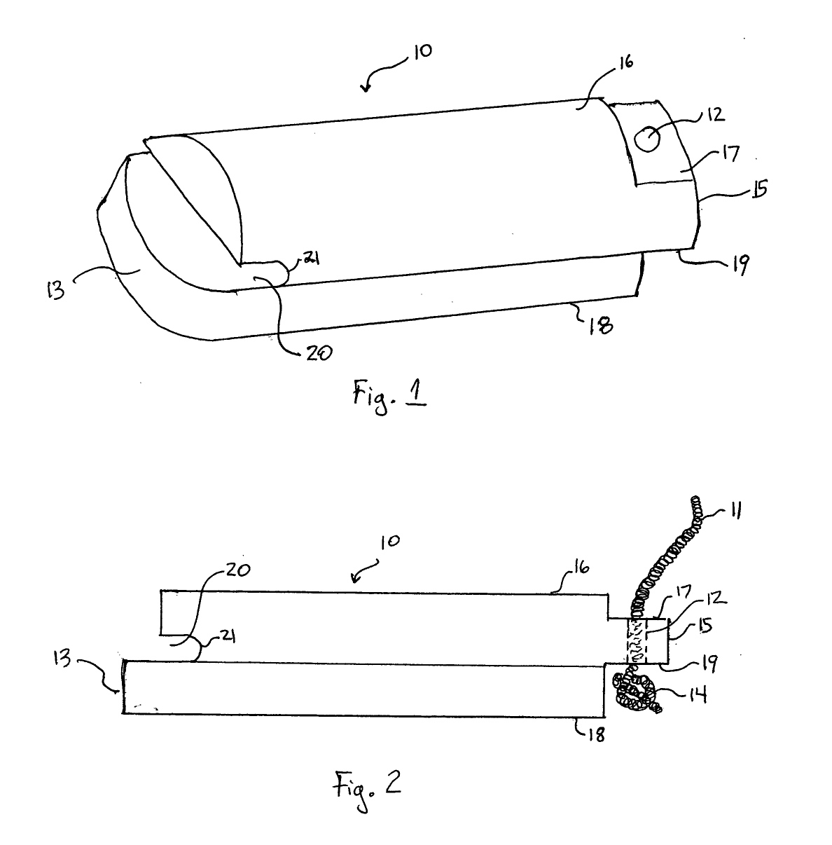

In one embodiment, as shown in FIGS. 1 and 2, stability is improved by ensuring the knotted rope or wire does not extend beyond a plane defined by a lower surface of the chock. This is achieved by providing a threaded portion at one end of the chock and extending from the chock, where the at least the lower surface of the threaded portion is spaced a certain distance from the lower surface of the chock itself.

More specifically, as shown in FIGS. 1 and 2, wheel chock 10 comprises an extended portion 15 having a through hole 12 therethrough. A line 11, either rope or wire or other equivalent attaching means, is threaded through the hole 12, and the distal end is knotted 14 to ensure the line 11 cannot be pulled back through the hole 12. The other end of the line 11 is attached to the other chock in the pair (not shown). Preferably, the upper and lower surfaces 17 and 19 of the extended portion 15 are respectively displaced from the upper and lower surfaces 16 and 18 of the wheel chock 10 itself. This ensures that the knot 14 does not extend below the plane defined by the lower surface 18 of the chock 10, thus preventing contact between the knot 14 and the ground. This prevents the knot 14 from fraying, and also ensures the lower surface 18 lies flat on the ground when in place. The upper surface of the 17 of the extending portion is preferably displaced from the upper surface 16 of the chock 10, but it need not be.

A second extended portion 13 may be provided at an opposite end of the chock 10 to act as a guide or ledge to facilitate insertion of the line 11 into recess 20. The line 11 leads to the other chock in the pair (not shown) when the chocks are stored together. The recess 20 keeps the line connected to the other chock in the pair from contacting the ground when placed in front of and behind a wheel when deployed. The recessed portion is curved 21 to prevent line chafing.

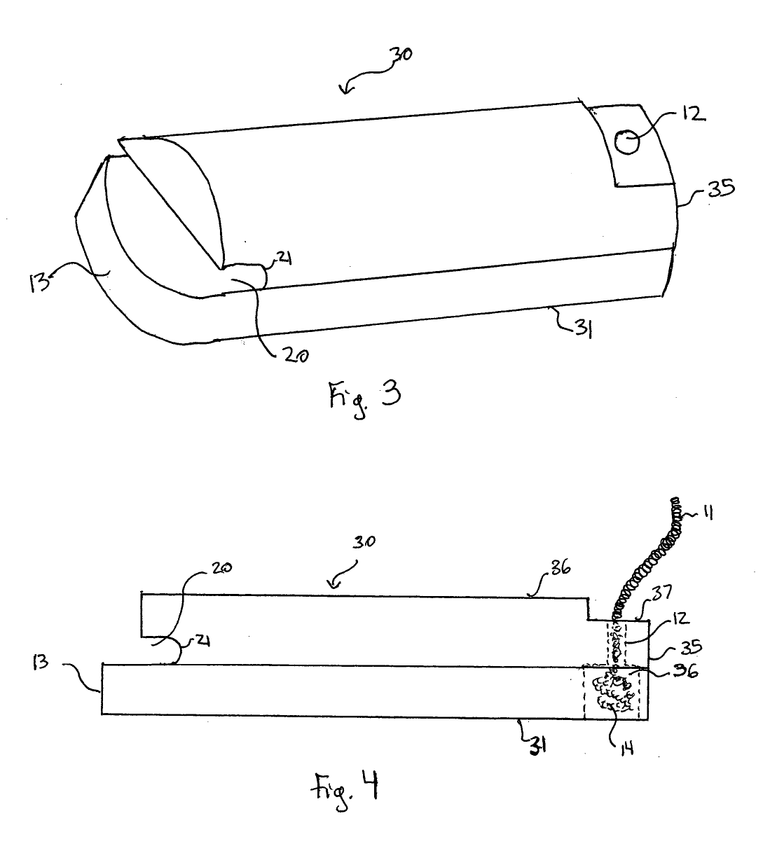

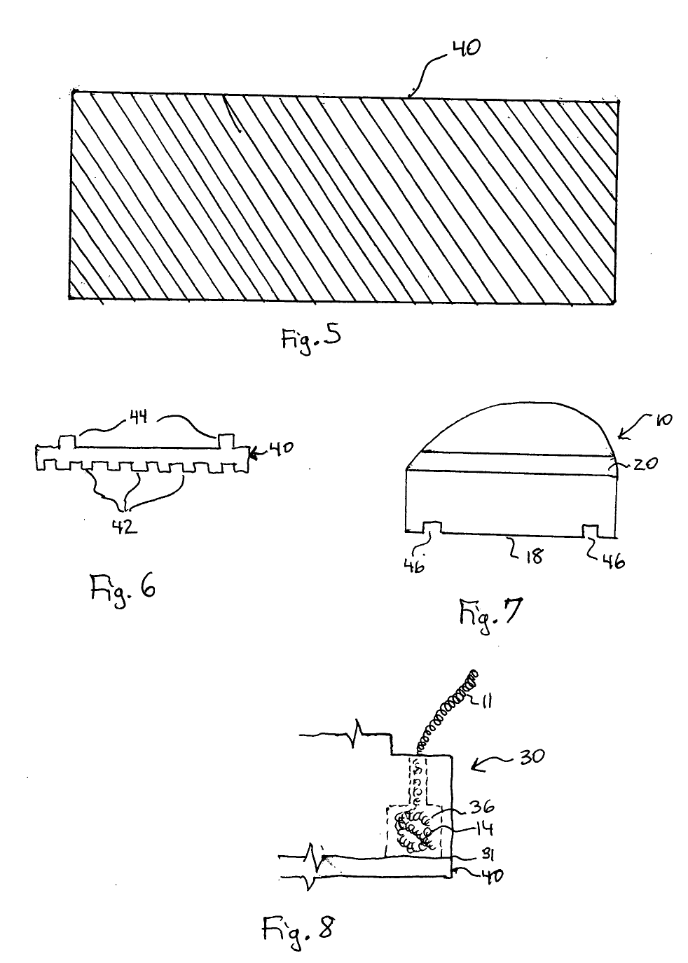

In another embodiment, as shown in FIGS. 3 and 4, stability is again improved by ensuring the knotted rope or wire does not extend beyond a plane defined by a lower surface of the chock. This is achieved in this embodiment by providing an internal cavity below the threaded portion at one end of the chock and extending from the chock, where the internal cavity is of sufficient size to accommodate a knotted rope or wire, without the allowing the knot to extend below the lower surface of the chock.

More specifically, as shown in FIGS. 3 and 4, wheel chock 30 comprises an extended portion 35 having a through hole 12 therethrough. A line 11 is threaded through the hole 12, and the distal end is knotted 14 to ensure the line 11 cannot be pulled back through the hole 12. The knot 14 resides in an internal cavity 36. While the internal cavity 36 is initially open at the lower surface 31 of the chock 30 to initially form the knot, the internal cavity 36 is of sufficient size to accommodate the knot 14, but not allow the knot 14 to extend beyond the lower surface 31 and contact the ground. This prevents the knot 14 from fraying, and also ensures the lower surface lies flat on the ground when in place. The internal cavity 36 can be left open at the lower surface 31 or later sealed. The upper surface of the 37 of the extending portion 35 is preferably displaced from the upper surface 36 of the chock 30, but it need not be.

As with the first embodiment, a second extended portion 13 may be provided at the opposite end of the chock 10 to act as a guide or ledge to facilitate insertion of the line 11 into recess 20. The recessed portion is curved 21 to prevent line chafing.

In another embodiment, as shown in FIGS. 5 through 8, traction is improved by attaching a traction layer to the lower surface of the chock 10 or 30. The traction layer in this embodiment is exemplified by traction pad 40, which is preferably made of rubber or other durable material to provide additional surface friction since the chocks themselves are generally made of wood or plastics, which could cause the chocks to slide more than if the traction layer where not provided. The traction pad 40 may be attached to the lower surface of the chock 18 using any conventional means, whether adhesively bonded, mechanically attached, or both, to thereby increase the coefficient of friction.

One example of an attachment means is the male-female attachment means shown in FIGS. 6 and 7. As shown in FIG. 6, the traction pad 40 is preferably ribbed in construction, containing a plurality of protruding portions 42 extending from the lower surface of the traction pad and contacting the ground. Of course, the traction pad 40 may also have a relatively planar lower surface, so long as the material of the traction pad 40 provides sufficient friction with the ground. The traction pad 40 also contains alignment ribs 44 protruding from the upper surface. The alignment ribs 44 fit into female grooves 46 formed in the lower surface 18 of the wheel chock 10 as shown in FIG. 7.

The traction pad 40 may extend along the entire lower surface or certain portions thereof, so long as sufficient ground friction is maintained. FIG. 8 shows a portion of the traction pad 40 attached to a portion of the lower surface of the chock 30 as shown in FIG. 4. After forming the knot 14 as described previously, the traction pad 40 is affixed to the lower surface 31, thereby entrapping the knot 14 in the internal cavity 36, and further preventing contact between the knot 14 and the ground.

While the present invention has been described in detail with reference to the preferred embodiments thereof, it should be understood to those skilled in the art that various changes, substitutions and alterations can be made hereto without departing from the scope of the invention as defined by the appended claims.

What is claimed is:

1. A wheel chock, comprising:
an elongated base member; and
a protruding portion extending from one end of the base member, a lower surface of the protruding portion being displaced from a lower surface of the base member, the protruding portion having a through hole extending from an upper surface of the protruding portion to the lower surface,
whereby a line extending through the hole, and knotted below the lower surface of the protruding portion, does not extend below the lower surface of the base member.

2. The wheel chock of claim 1, further comprising a traction layer affixed to the lower surface of the base member.

3. A wheel chock, comprising:
an elongated base member; and
a protruding portion extending from one end of the base member, the protruding portion having a through hole extending from an upper surface of the protruding portion to an internal cavity disposed within the base member and communicating with the through hole,
whereby a line extending through the hole, and knotted within the internal cavity, does not extend below a lower surface of the base member.

4. The wheel chock of claim 3, further comprising a traction layer affixed to the lower surface of the base member.
